(19) United States
(12) Patent Application Publication
(10) Pub. No.: US 2009/0002065 A1
(43) Pub. Date: Jan. 1, 2009

(54) Buffer circuit for reducing differential-mode phase noise and quadrature phase error

(76) Inventors: Ahmad Mirzaei, Los Angeles, CA (US); Hooman Darabi, Irvine, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/823,079

(22) Filed: Jun. 26, 2007

(51) Int. Cl. H04B 1/10

(52) U.S. Cl. 327/551

(57) ABSTRACT

According to one exemplary embodiment, a buffer circuit for reducing differential-mode phase noise and quadrature phase error comprises first and second switching branches driven by an in-phase (I) signal, third and fourth switching branches driven by a quadrature-phase (Q) signal, the first and second switching branches and third and fourth switching branches being coupled to a common bias current source to reduce the differential-mode phase noise and quadrature phase error at an output of the buffer circuit. In one embodiment, the switching branches may be loaded by first, second, third, and fourth resonators formed, for example, by L-C circuits tuned to a local oscillator frequency. In one embodiment, the buffer circuit may comprise switching branches formed by FETs, and be used in conjunction with a local oscillator and mixer circuits to down-convert a radio frequency (RF) signal, in a receiving system, for example.

### BACKGROUND OF THE INVENTION

1. Field of the Invention

The present invention is generally in the field of electronic circuits and systems. More specifically, the present invention is in the field of communications circuits and systems.

2. Background Art

Buffer circuits are typically used in receiving systems to, for example, buffer and amplify a local oscillator signal for driving mixer circuits. The mixer circuits may be used, along with in-phase (I) and quadrature-phase (Q) output signal components from the local oscillator, to down-convert an input radio frequency (RF) signal. Although conventional buffer circuits provide buffering and amplification in transfer of a local oscillator signal to mixers in a communications system, conventional implementations provide no correction for signal errors introduced during generation of the I and Q signal components.

Generation of local oscillator signals may include several significant sources of signal error. One such source is the quadrature phase error, introduced by the local oscillator splitter when a local oscillator signal is divided into its I and Q components. Another is phase noise, which is an instantaneous frequency error in a generated signal prior to separation of the I and Q components. Because phase noise is produced prior to separation of the I and Q signal components, phase noise affects both signal components, but not necessarily in the same way. Where phase noise introduces opposite frequency shifts to the I and Q signal components, the error is known as differential-mode phase noise, and may be particularly difficult to eliminate during subsequent signal processing. By failing to remedy the differential-mode phase noise and quadrature phase errors generated by a local oscillator, and instead allowing them to enter the mixers, conventional buffer circuits propagate those errors. As a result, conventional buffer circuits may permit even a highly pure input RF signal to become significantly degraded due to mixing with signal errors produced by the local oscillator.

Thus, there is a need in the art for a buffer circuit capable of reducing or eliminating the differential-mode phase noise and the quadrature phase error present in signals provided at its inputs.

### SUMMARY OF THE INVENTION

A buffer circuit for reducing differential-mode phase noise and quadrature phase error, substantially as shown in and/or described in connection with at least one of the figures, and as set forth more completely in the claims.

### BRIEF DESCRIPTION OF THE DRAWINGS

FIG. 1 shows a conventional implementation of buffer circuits.

FIG. 2A shows the effect of phase noise on in-phase (I) and quadrature-phase (Q) signal components in the time domain.

FIG. 2B shows a frequency domain graph of an ideal input signal to the buffer circuits of FIG. 1.

FIG. 2C shows the effect of differential-mode phase noise on the frequency distribution of the input signal of FIG. 2B.

FIG. 3A shows a phasor diagram displaying the effect of quadrature phase error on the phase relationship between I and Q signal components.

FIG. 3B shows the effect of quadrature phase error on I and Q signal components in the time domain.

FIG. 4 illustrates a buffer circuit for reducing differential-mode phase noise and quadrature phase error, according to one embodiment of the present invention.

FIG. 5 shows a graph relating the I and Q inputs of the circuit embodied in FIG. 4, to its outputs.

FIG. 6 illustrates a buffer circuit for reducing differential-mode phase noise and quadrature phase error, according to another embodiment of the present invention.

### DETAILED DESCRIPTION OF THE INVENTION

The present invention is directed to a buffer circuit for reducing differential-mode phase noise and quadrature phase error. The following description contains specific information pertaining to the implementation of the present invention. Although the invention is described with respect to specific embodiments, the principles of the invention, as defined by the claims appended herein, can be applied beyond the specified embodiments of the invention described. Moreover, some of the specific details of the invention are not discussed in order not to obscure the invention. The specific details not described in the present application are within the knowledge of a person of ordinary skill in the art.

The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

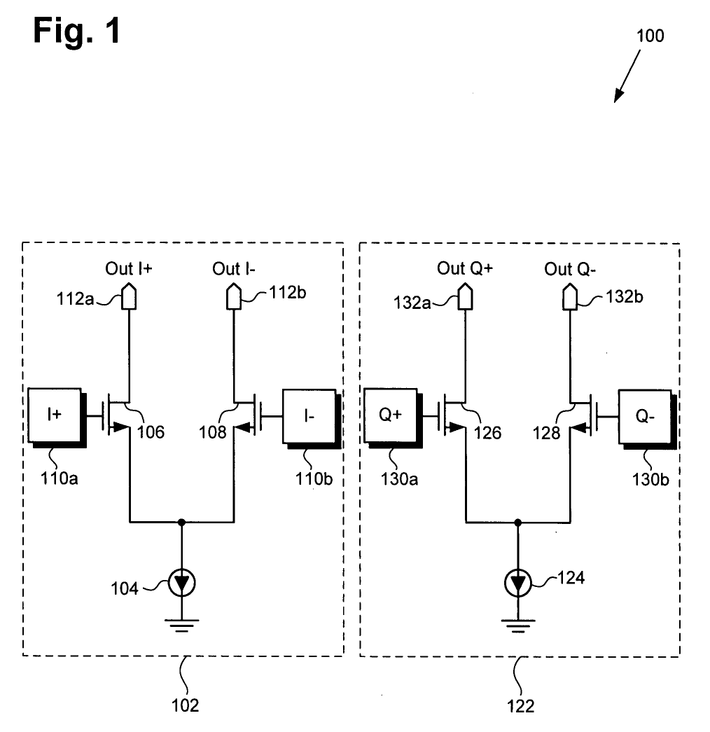

FIG. 1 shows a conventional implementation of buffer circuits. As shown in FIG. 1, buffer 100 comprises buffer circuits 102 and 122. Buffer 100 in FIG. 1 comprises separate buffer circuits to receive the in-phase (I) and quadrature-phase (Q) signal components of a local oscillator as inputs, for example. Buffer circuit 102 includes bias current source 104, field effect transistors (FETs) 106 and 108, in-phase positive (I+) input 110a, in-phase negative (I−) input 110b, I+output 112a, and I− output 112b. Buffer 100 also includes buffer circuit 122, comprising bias current source 124, FETs 126 and 128, quadrature-phase positive (Q+) input 130a, quadrature-phase negative input (Q−) 130b, Q+ output 132a, and Q− output 132b. In the conventional implementation shown in FIG. 1, signal errors generated during production of the I and Q signal components are propagated through separate buffer circuits 102 and 122 to the load circuits receiving the outputs of buffer 100, at I+output 112a, I− output 112b, Q+ output 132a, and Q− output 132b. Two significant sources of such signal error are phase noise and quadrature phase error.

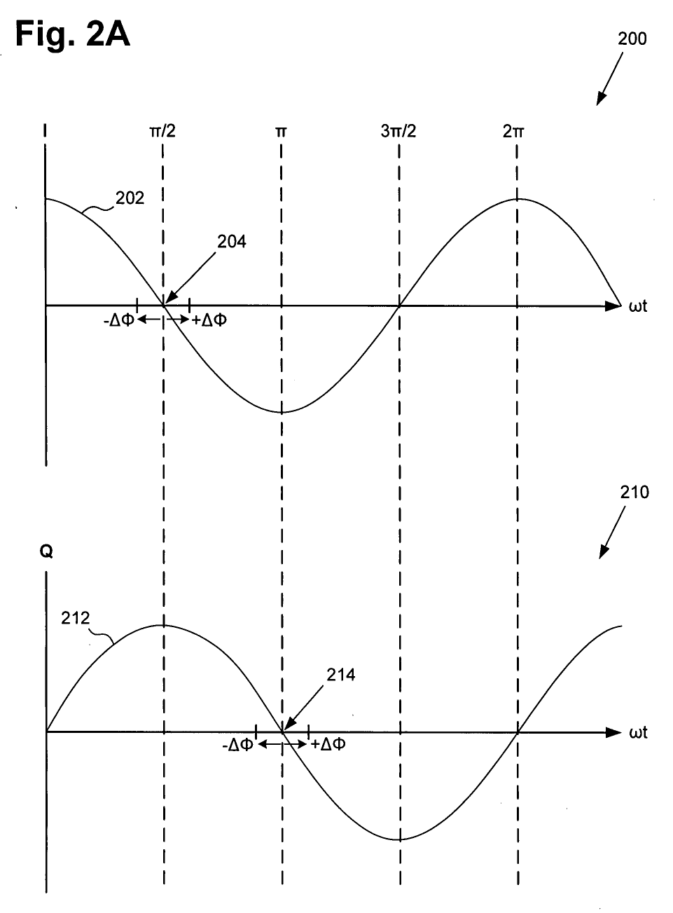

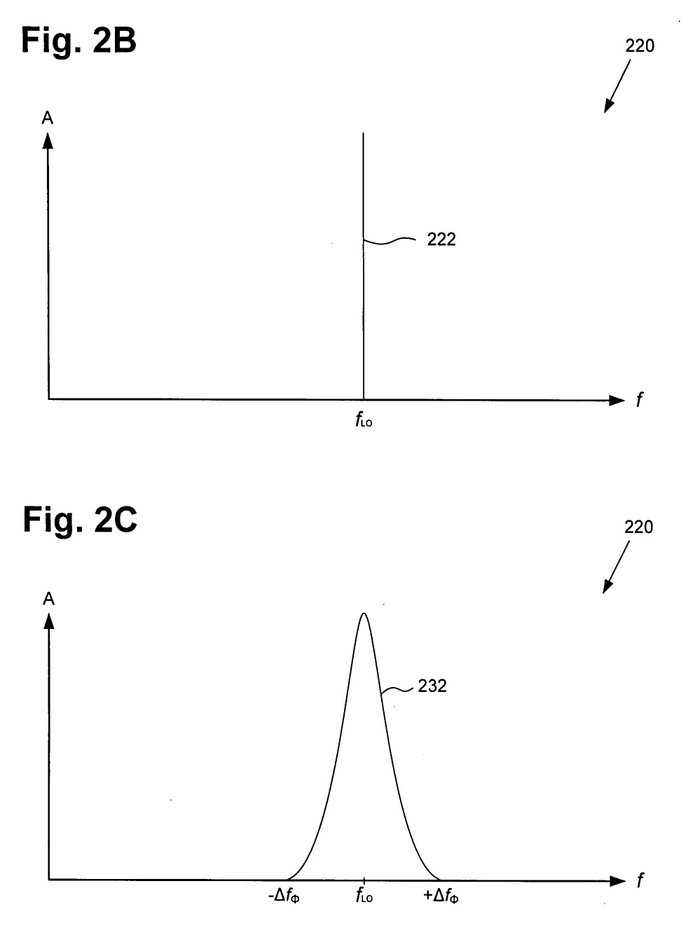

FIG. 2A shows the effect of phase noise on I and Q signal components in the time domain. Phase noise is a spontaneous frequency deviation generated by a signal generator, for example a local oscillator, prior to separation of the I and Q signal components. Graph 200 in FIG. 2A shows the amplitude of the I signal component as a function of phase; where phase is expressed as the product of angular frequency and time (ωt). Sinusoidal curve 202 represents a pure I signal, that is, one unaffected by phase noise. The effect of phase noise is shown on graph 200 by the intervals +Δφ and −Δφ bordering point 204 at a first zero crossing of curve 202, at ωt=π/2; where Δφ is the magnitude of the phase noise in radians.

Similarly, graph 210 shows the amplitude of the Q signal component as a function of ωt. Curve 212 represents a Q signal unaffected by phase noise, lagging curve 202 of the I component by exactly π/2. The effect of phase noise is shown on graph 210 by the intervals +Δφ and −Δφ bordering point 214 at a first Q zero crossing at ωt=π. Differential-mode phase noise, which may be particularly difficult to eliminate during subsequent signal processing, is present when a zero crossing of the I signal occurs, not at ωt=π/2, but at ωt=π/2−Δφ, and is followed by a zero crossing of the Q signal shifted in the opposite phase direction, at ωt=π+Δφ, for example.

Turning to FIG. 2B, graph 220 in FIG. 2B shows a frequency domain graph of an ideal input signal to buffer 100 in FIG. 1. Graph 220 shows signal spectrum, corresponding to the amplitudes of both the I and Q inputs (e.g. in-phase positive inputs 110a, 110b, and quadrature-phase inputs 130a, 130b) to buffer 100 in FIG. 1, as a function of frequency (ƒ). For an ideal signal, the frequency spectrum of the signal provided to the I and Q inputs is shown by impulse 222 at local oscillator frequency ƒ_{LO}, for example, 2.0 GHz for a buffer utilized in a radio frequency (RF) receiver.

FIG. 2C shows the effect of differential-mode phase noise on the frequency distribution of the input signal of FIG. 2B. As in the previous figure, graph 232 in FIG. 2C shows I and Q inputs to buffer 100 in FIG. 1, as a function off. Here, as a result of differential-mode phase noise, the frequency spectrum of the signal provided to the I and Q inputs is shown by curve 232, corresponding to a band of frequencies across central frequency ƒ_{LO}, extending from (ƒ_{LO}-Δƒ_{φ}) to (ƒ_{LO}+Δƒ_{φ}); where Δƒ₁₀₀ is the frequency variation caused by phase noise.

In addition to differential-mode phase noise, another significant source of signal error is quadrature phase error. Quadrature phase error occurs during separation of a signal into its I and Q components. Whereas an ideal I and Q signal set would be phase shifted from one another by exactly π/2, quadrature phase error results in a small deviation in the actual phase difference, so that the I and Q signal components are shifted, for example, by π/2−σ rather than exactly π/2; where σ is the quadrature phase error in radians.

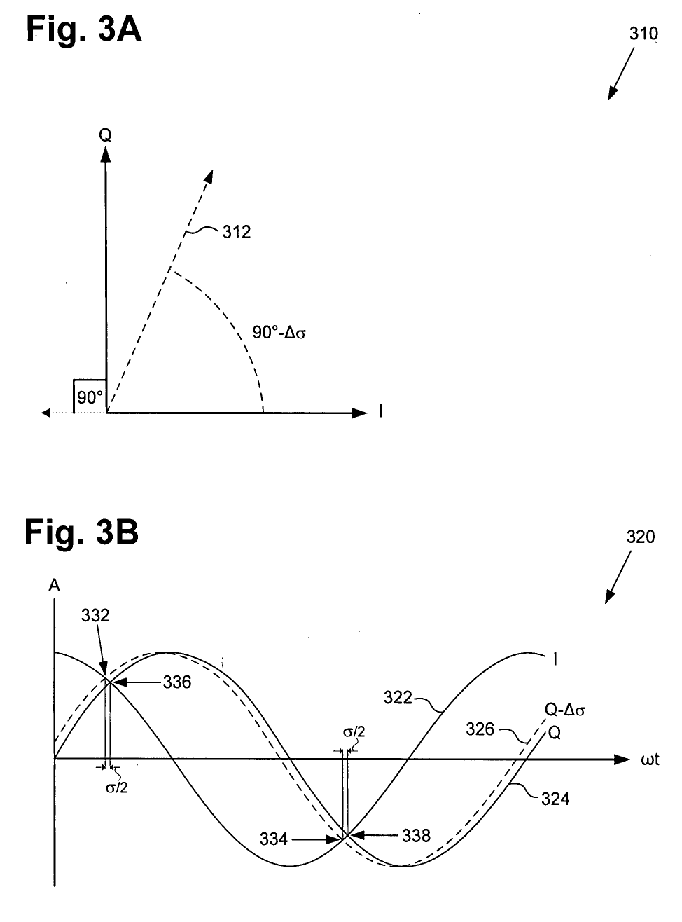

FIG. 3A shows a phasor diagram displaying the effect of quadrature phase error on the phase relationship between the I and Q signal components. In FIG. 3A, the I component forms the real axis of graph 310 in the complex plane, while, in the absence of a quadrature-phase error, the Q component would form the imaginary axis. Phasor 312 shows the Q signal component resulting from a quadrature phase error of Δσ. As shown on graph 310, the presence of quadrature phase error Δσ results in Q being converted from a purely imaginary phasor, to one having both real and imaginary parts.

FIG. 3B shows the effect of quadrature phase error on I and Q signal components in the time domain. Graph 320 in FIG. 3B shows the amplitude of the I and Q signal components as a function of phase, given by ωt. Curve 322 shows the sinusoidal variation of I and curve 324 shows the variation of an ideal Q, while dashed-line curve 326 shows the effect of quadrature phase error Δσ. It is worthy of note at this time, although its importance will not be fully developed until later, that a phase error of Δσ from perfect quadrature results in a shift of the intersection points 332 and 334 of curves 322 and 326 by only Δσ/2, compared to the intersections of ideal quadrature signals shown at points 336 and 338 for curves 322 and 324.

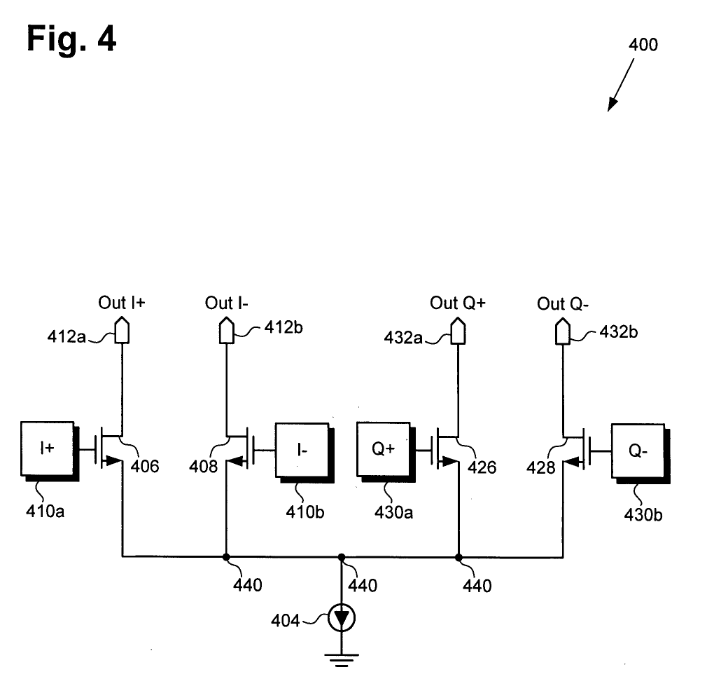

FIG. 4 illustrates a buffer circuit for reducing differential-mode phase noise and quadrature phase error, according to one embodiment of the present invention. Circuit 400 in FIG. 4 comprises transistors 406, 408, 426, and 428, as well as I+ input 410a, I− input 410b, Q+ input 430a, and Q− input 430b, corresponding respectively to transistors 106, 108, 126, and 128, and I+ input 110a, I− input 110b, Q+ input 130a, and Q− input 130b, in FIG. 1. Also present in FIG. 4 are buffer circuit outputs shown by I+ output 412a, I− output 412b, Q+ output 432a, and Q− output 432b, corresponding respectively to I+ output 112a, I− output 112b, Q+ output 132a, and Q− output 132b, in FIG. 1.

According to the present invention, the novel utilization of commonly shared bias current source 404 results in the advantageous coupling of the sources of transistors 406, 408, 426, and 428, and producing single buffer circuit 400. In its present embodiment, buffer circuit 400 might be used as a buffer for a local oscillator producing an RF signal and for driving mixer circuits in various systems, such as a wireless telephone receiver, a satellite set-top box, or a Bluetooth enabled device, for example.

In the embodiment of the present invention shown in FIG. 4, transistors 406 and 408 form first and second switching branches driven by I signal components provided at I+ input 410a and I− input 410b, while transistors 426 and 428 form third and fourth switching branches driven by Q signal components provided at Q+ input 430a and Q− input 430b. The first and second switching branches formed by transistors 406 and 408 are coupled to the third and fourth switching branches formed by transistors 426 and 428 at common node 440 and through shared common bias current source 404. As a result, the operation of the first and second, and third and fourth switching branches is coordinated in such a way that differential-mode phase noise and quadrature phase error present in input signals to buffer circuit 400, are reduced or eliminated at its outputs. While in the present embodiment, FETs (field effect transistors) are utilized as transistors 406, 408, 426, and 428, to provide the first and second, and third and fourth switching branches, in other embodiments, transistors 406, 408, 426, and 428 may be replaced by other switching components, for example, bipolar transistors, or a combination of transistors, including or not including FETs and/or bipolar transistors.

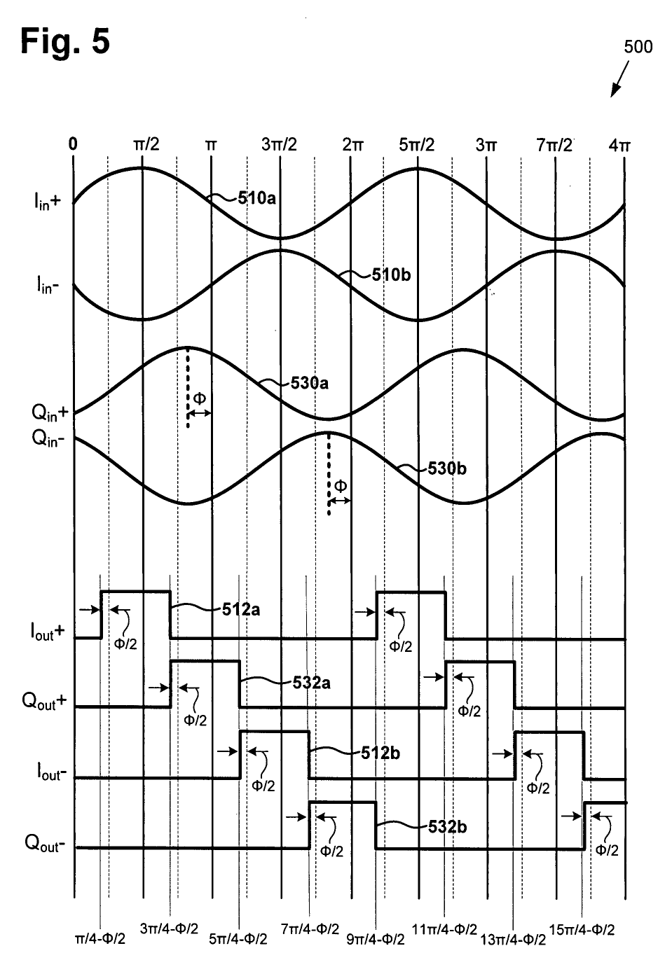

The functionality of buffer circuit 400 in FIG. 4 can be explained by reference to its input and output signals as discussed in relation to FIG. 5. FIG. 5 shows a graph relating the I and Q inputs of the circuit embodied in FIG. 4, to its outputs. Graph 500 in FIG. 5 shows the signal at I+ input 410a in FIG. 4, as waveform 510a in the time domain, additionally labeled as Iᵢₙ+. In similar fashion, waveforms 510b, 530a, and 530b, correspond respectively to I− input 410b, Q+ input 430a, and Q− input 430b. Also shown in FIG. 5 are buffer circuit output waveforms 512a, 532a, 512b, and 532b, corresponding respectively to the signals at I+ output 412a, Q+ output 432a, I− output 412b, and Q− output 432b.

In addition, FIG. 5 includes input phase variation φ and output phase correction interval φ/2. In the discussion to follow, it is important to bear in mind that input phase variation φ corresponds to a phase shift taking I and Q out of perfect quadrature, and arising from any pre-input source of signal error, including differential-mode phase noise, quadrature phase error, or both. In addition, output phase correction φ/2 is a phase adjustment imposed equally on all output signal components as a result of the operation of the present embodiments buffer circuit in response to input phase variation φ. Finally, it is noted that the order of presentation of the signal outputs is different from that of the signal inputs, that is inputs are presented in the order I+, I−, Q+, Q−, while the outputs are presented in order I+, Q+, I−, Q−, for reasons that will become apparent.

Continuing with FIGS. 4 and 5, it can be seen from circuit 400 that coupling of the first and second, and third and fourth switching branches as a result of coupling at common node 440 of common bias current source 404 results in only one switching branch being activated at a time. This corresponds to output current being provided to I+output 412a, or I− output 412b, or Q+ output 432a, or Q− output 432b, but not to more than one at any one time. Which of the switching branches will be activated at a particular time depends on the their input signals. Simply put, the switching branch having the highest amplitude input signal, i.e. highest gate voltage in the present embodiment, is activated, while the others are not. Comparison of the varying waveform inputs shown in FIG. 5 makes it clear that the relationship amongst the input signals will govern the transitions in the output signals. That fact follows from the coupling of the switching branches at common node 440 and explains the advantageous result of the present invention, i.e. that the present invention accomplishes reduction or elimination of differential-mode phase noise and quadrature phase error.

Returning to FIG. 5, it can be seen that for I and Q components in perfect quadrature, Iᵢₙ+ has the largest amplitude of the four input signals during the interval ωt=π/4 (half way point between 0 and π/2 shown in graph 500) to ωt=3π/4 (half way point between π/2 and T shown in graph 500). Consequently, in the ideal case, during that interval only the first switching branch would be active in FIG. 4, providing output current only through transistor 406 at I+ output 412a. Similarly, for the ideal case, during the interval ωt=3π/4 (half way point between π/2 and π shown in graph 500) to ωt=5π/4 (half way point between π and 3π/2 shown in graph 500), Qᵢₙ+ has the largest amplitude, resulting in output current only at Q+ output 432a, in FIG. 4.

The relationship of the output signals is shown in FIG. 5, where it can be seen from output waveforms 512a, 532a, 512b, and 532b, that transitions from output to output correspond to transitions between input signals. This can be seen as well from FIG. 3B, where the transition from I to Q corresponds to their intersection point at point 336. As stated in relation to FIG. 3B, a phase error between the I and Q components, of magnitude Δσ, translates to a shift in their intersection point of Δσ/2 in that Figure. Because the transitions in the outputs shown in FIG. 5 correspond to intersection points of I and Q components, it is easy to see from graphs 320 and 500 that an input phase variation of φ in FIG. 5 produces an output phase correction of φ/2, applied to each output. As a result, all output signals are shifted equally, while their transitions are tied to one another through the coupling of the switching branches producing them, so that despite an input phase error, the outputs are perfectly phase shifted with respect to one another, in other words their outputs are phase aligned.

At a more rigorous level, the fact that a phase variation from perfect quadrature between a sine function and a cosine function of magnitude φ results in a shift of their intersection points by φ/2 can be shown mathematically. However, such a proof is cumbersome due to the necessity of manipulating trigonometric identities. For that reason, and because the mathematics is both well known and may be readily referenced by one of ordinary skill in the art, a mathematical proof is not presented here.

Thus, while the conventional approach to implementing buffer circuits described in conjunction with FIG. 1 results in the differential-mode phase noise and quadrature phase error generated during generation of input signals to be propagated on to its output signals, the present invention's buffer circuit can substantially reduce or eliminate those signal errors. This outcome may be particularly advantageous when the buffer circuit outputs are fed to RF mixers, for example. In that case, the conventional implementation causes the signal errors introduced by a local oscillator to be imposed on an RF reception signal, thereby undesirably degrading the reception signal's quality. By contrast, the present invention reduces or eliminates those local oscillator signal errors at its own outputs, thereby preserving reception signal quality.

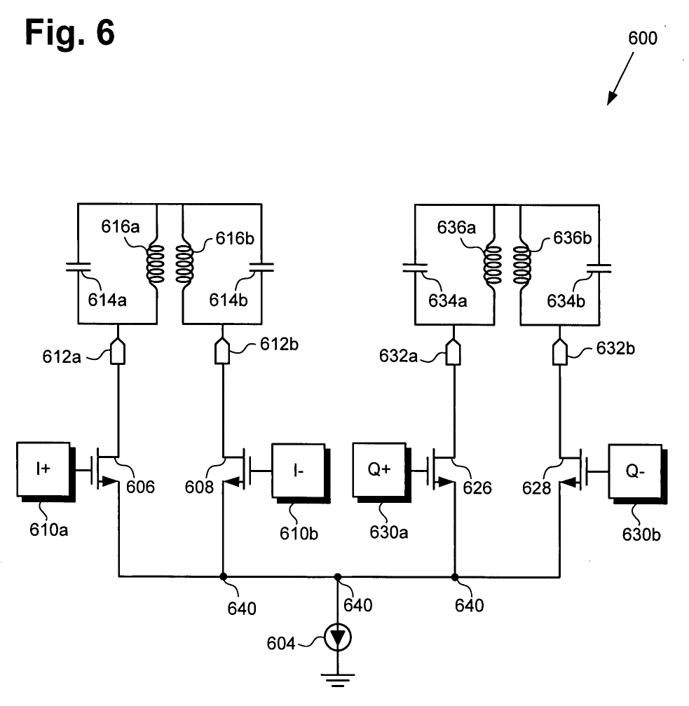

FIG. 6 illustrates a buffer circuit for reducing differential-mode phase noise and quadrature phase error, according to another embodiment of the present invention. Buffer circuit 600 in FIG. 6 comprises common bias current source 604 connected to common node 640, transistors 606, 608, 626, and 628, as well as I+ input 610a, I− input 610b, Q+ input 630a, and Q− input 630b, corresponding respectively to common bias current source 404 connected to common node 440, transistors 406, 408, 426, and 428, as well as I+ input 410a, I− input 410b, Q+ input 430a, and Q− input 430b, in FIG. 4. In addition, FIG. 6 includes buffer circuit outputs shown by I+ output 612a, I− output 612b, Q+ output 632a, and Q− output 632b, corresponding respectively to I+ output 412a, I− output 412b, Q+ output 432a, and Q− output 432b, in FIG. 4. Also shown in FIG. 6 are capacitors 614a, 614b, 634a, and 634b, and inductors 616a, 616b, 636a, and 636b, having no analogues in previous figures.

In the embodiment of FIG. 6, capacitor 614a and inductor 616a form an L-C circuit serving as a first resonator loading I+ output 612a. Similarly, capacitors 614b, 634a, and 634b join respectively with inductors 616b, 636a, and 636b, to form L-C circuits serving as respective second, third, and fourth resonators, for the outputs at I− output 612b, Q+ output 632a, and Q− output 632b. Selected so as to be tuned to a local oscillator frequency, the L-C circuits formed by capacitors 614a, 614b, 634a, and 634b, and inductors 616a, 616b, 636a, and 636b can suppress harmonics of the signal frequency provided at outputs 612a, 612b, 632a, and 632b, thereby providing sinusoidal output signals, rather than the flattened (i.e. square wave or approximately square wave) outputs produced by circuit 400 of FIG. 4, and shown as output waveforms 512a, 532a, 512b, 532b, in FIG. 5.

In its various embodiments, the present invention's buffer circuit for reducing differential-mode phase noise and quadrature phase error can be utilized in an electronic system in, for example, a wired communications device, a wireless communications device, a cell phone, a Bluetooth enabled device, a computer, a monitor, a television set, a satellite set-top box, a cable modem, an audio or video receiver, an RF transceiver, a personal digital assistant (PDA), or in any other kind of system, device, component or module utilized as a receiver in modern electronics applications.

Thus, the described embodiments of the present invention's buffer circuit for reducing differential-mode phase noise and quadrature phase error advantageously reduce or eliminate signal errors present at its inputs. By coupling first and second, and third and fourth switching branches through a common bias current source, the present invention synchronizes activation of those branches, thereby distributing an input phase variation as an output phase correction, resulting in phase alignment of the output signals. As a result, the present invention reduces or eliminates differential-mode phase noise and quadrature phase error produced by a signal generator.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

Thus, a buffer circuit for reducing differential-mode phase noise and quadrature phase error has been described.

1. A buffer circuit for reducing differential-mode phase noise and quadrature phase error, said buffer circuit comprising:
first and second switching branches driven by an in-phase signal;
third and fourth switching branches driven by a quadrature-phase signal;
said first and second switching branches and said third and fourth switching branches being coupled to a common bias current source to reduce said differential-mode phase noise and quadrature phase error at an output of said buffer circuit.

2. The buffer circuit of claim 1 wherein each of said first and second switching branches and said third and fourth switching branches comprises at least one transistor.

3. The buffer circuit of claim 2 wherein said at least one transistor is a FET.

4. The buffer circuit of claim 3 wherein a gate of said FET is driven by said in-phase signal and a source of said FET is coupled to said common bias current source.

5. The buffer circuit of claim 3 wherein a gate of said FET is driven by said quadrature-phase signal and a source of said FET is coupled to said common bias current source.

6. The buffer circuit of claim 3 wherein a drain of said FET provides a buffered output signal.

7. The buffer circuit of claim 1, further comprising:
first and second resonators respectively loading said first and second switching branches, and third and fourth resonators respectively loading said third and fourth switching branches.

8. The buffer circuit of claim 7 wherein each of said first and second and said third and fourth resonators comprises an L-C circuit.

9. The buffer circuit of claim 8 wherein said L-C circuit is tuned to a local oscillator frequency producing said in-phase signal and said quadrature-phase signal.

10. The buffer circuit of claim 1 wherein said output of said buffer circuit drives a mixer circuit.

11. The buffer circuit of claim 1 wherein said buffer circuit is utilized in an electronic system, said electronic system being selected from the group consisting of a wired communications device, a wireless communications device, a cell phone, a Bluetooth enabled device, a computer, a monitor, a television set, a satellite set-top box, a cable modem, an audio or video receiver, an RF transceiver, and a personal digital assistant (PDA).

12. A buffer circuit for reducing differential-mode phase noise and quadrature phase error, said buffer circuit comprising:
first and second switching branches driven by an in-phase signal, said first and second switching branches being loaded by respective first and second resonators;
third and fourth switching branches driven by a quadrature-phase signal, said third and fourth switching branches being loaded by respective third and fourth resonators;
said first and second switching branches and said third and fourth switching branches being coupled to a common bias current source to reduce said differential-mode phase noise and quadrature phase error at an output of said buffer circuit.

13. The buffer circuit of claim 12 wherein each of said first and second switching branches and said third and fourth switching branches comprises at least one transistor.

14. The buffer circuit of claim 13 wherein said at least one transistor is a FET.

15. The buffer circuit of claim 14 wherein a gate of said FET is driven by said in-phase signal and a source of said FET is coupled to said common bias current source.

16. The buffer circuit of claim 14 wherein a gate of said FET is driven by said quadrature-phase signal and a source of said FET is coupled to said common bias current source.

17. The buffer circuit of claim 14 wherein a drain of said FET provides a buffered output signal.

18. The buffer circuit of claim 12 wherein each of said first and second and said third and fourth resonators comprises an L-C circuit.

19. The buffer circuit of claim 18 wherein said L-C circuit is tuned to a local oscillator frequency producing said in-phase signal and said quadrature-phase signal.

20. The buffer circuit of claim 12 wherein said buffer circuit is utilized in an is electronic system, said electronic system being selected from the group consisting of a wired communications device, a wireless communications device, a cell phone, a Bluetooth enabled device, a computer, a monitor, a television set, a satellite set-top box, a cable modem, an audio or video receiver, an RF transceiver, and a personal digital assistant (PDA).
